(19) United States
(12) Patent Application Publication
(10) Pub. No.: US 2014/0261231 A1
(43) Pub. Date: Sep. 18, 2014

(54) PET PRODUCTS HAVING ORAL CARE PROPERTIES

(71) Applicants: Ronald K. DUNTON, Burlington, WA (US); Andrew M. HOMOLA, Naples, FL (US); Robert G. PITTS, Colorado Springs, CO (US)

(72) Inventors: Ronald K. DUNTON, Burlington, WA (US); Andrew M. HOMOLA, Naples, FL (US); Robert G. PITTS, Colorado Springs, CO (US)

(21) Appl. No.: 13/799,586

(22) Filed: Mar. 13, 2013

(51) Int. Cl. A01K 11/00

(52) U.S. Cl. CPC A01K 15/026
USPC 119/710

(57) ABSTRACT

The present application provides an edible pet chew having a moisture content of 15 to 30 wt % and contains 15 to 35 wt % of gelatin, 10 to 30 wt % of flavoring ingredients, 2 to 10 wt % of structure-providing components, 1 to 5 wt % of humectant, 0.1 to 0.2 wt % of preservatives, and 10 to 25 wt % of a dental protection composition. The present application also provides a chewable rope embodiment containing a rope either impregnated with 10 to 25 wt % of a dental protection composition or containing a rope coated with the edible pet chew formulation.

### BACKGROUND OF THE INVENTION

Pets, such as dogs and cats, are subject to dental health problems like their human counterparts. These problems can be traced to the formation of bacterial plaque which forms on the exterior surface of teeth. Plaque is a gelatinous mass of sticky film of bacteria, polysaccharides and salivary proteins which are not easily washed away. Plaque is now generally recognized as the main culprit of poor oral health. Bacteria that produce the acid for the caries process are held to the tooth surface by the plaque matrix as well as other bacterial agents which cause redness and swelling (i.e., gingivitis). The anaerobic microbial species which can proliferate when plaque is left undisturbed are also responsible for oral malodor and periodontitis which, if left untreated, can result in tooth loss.

Dental calculus, or tartar as it is commonly called, is the result of the thickening and hardening (mineralization) of dental plaque. Tartar which is not easily removed accumulates on the tooth surface, mainly at the gingival margin. It is a hard mineral deposit containing predominantly calcium and phosphate, very tightly bound to the tooth surface. In addition to being unsightly and undesirable from an aesthetic standpoint, tartar deposits (i.e., mature calculus deposits) can, when it extends below the gingival margin, be constant sources of irritation of the gingiva and is therefore a contributing factor to gingivitis and its sequelae. Once mature and hardened tartar is formed, it can be difficult to remove and the assistance of a veterinary professional is typically sought. Thus, not only is tartar elimination sought after once it occurs, but prevention, or at least mitigation, of further or new tartar buildup is also desired.

Currently, there is one dental product for pets such as cats and dogs that is applied by a veterinarian or a veterinarian assistant immediately following a professional dental cleaning to provide enduring protection against plaque adherence and the consequences thereof. The pet owner is then sent home with a follow-up home-care product that is to be applied by the pet owner to the pet's teeth via a swab, finger or other convenient applicator. However, it has been found that many pet owners are unable or unwilling to place their fingers in or near the pet's teeth. Thus, the follow-up care is neglected by the pet owner and the pet suffers from new plaque accumulation which can lead to gingivitis, periodontitis and caries, etc.

Also, current commercial pet products that are edible, for example dog bones or cat treats, when chewed by the animal, typically do not provide sufficient mechanical surface cleaning to teeth to provide for plaque removal from the animal's teeth necessary for optimum dental health. For instance, because animals like dogs and cats tend to bite or tear and then swallow their food without much chewing, it is difficult to obtain sufficient contact between the pet product and all portions of the mouth, i.e., both sides as well as the anterior and posterior portions of the pet's dentition.

There is therefore a need in the pet product industry for a pet product which provides enduring oral care properties when chewed by a pet, for example a dog or cat.

### BRIEF SUMMARY OF THE INVENTION

The present invention is directed to a pet product that provides for the application/deposition of a dental protection composition by the action of chewing, as well as providing for mechanical surface cleaning of the teeth during chewing.

The present invention provides an edible, easily digestible pet chew that promotes oral health and can help to prevent bad breath in animals. The present invention also provides a chewable rope.

### BRIEF DESCRIPTION OF THE DRAWINGS

FIG. 1 depicts a first bone-shaped embodiment of an edible pet chew.

FIG. 2 depicts a second bone-shaped embodiment of an edible pet chew.

FIG. 3 depicts a worm-like embodiment of an edible pet chew.

FIGS. 4A, 4B depict ridge-containing and/or texture-containing embodiments of an edible pet chew.

FIG. 5 depicts an embodiment of a chewable rope.

### DETAILED DESCRIPTION OF THE INVENTION

### I. Edible Pet Chew

The present invention provides an easily-digestible edible pet chew that promotes oral health and prevents bad breath in animals. The pet chew is specifically formulated using a gelatin-based composition to produce a soft chew that promotes chewing and is quickly and completely digested by a pet. The pet chew is further infused with a structure-providing component which can include abrasive agents, for example coconut fibers and powdered cellulose. Also various cellulose fibers such as hemp, cotton, coir, agave and animal-based fibers such as silk, wool, alpaca or mohair can be incorporated. The texture of the abrasive agents gently abrade the teeth to eliminate tartar and plaque while the animal is chewing. The unique combination of the soft texture of the gelatin-based composition and the infusion with structure-providing components encourages the animal to chew the treat longer, thus enhancing the application/deposition of a dental protection composition without the pet chew breaking apart and being swallowed prematurely. The abrasive agents also function to remove surface detritus on teeth including for example mucus, so that the dental protection composition is more readily deposited without inhibition of the detritus, mucus, etc.

In one embodiment of the edible pet chew, see FIG. 1, the pet chew is shaped like a bone to appeal to a dog, but has soft rounded edges and a flat shape to reduce the risk of pieces breaking off and choking the animal or damaging the internal digestive lining. Another embodiment of the bone-shaped pet chew, see FIG. 2, has an increased content of the fiber-based component. A similar pet chew intended to appeal to cats can be shaped like a worm, see FIG. 3, and can optionally be infused with catnip to attract and keep a cat's interest. Additional shapes or geometries may be applied to the edible pet chew as desired, and can include, for instance those of FIG. 4A or FIG. 4B.

The use of abrasive agents, for example coconut fibers, powdered cellulose, etc. contributes to the pet chew's ability to improve the overall oral hygiene in animals. Abrasive agents act simply to create friction against a dog's tooth when the dog is chewing the abrasive substance, thereby removing plaque and tartar buildup. In the present disclosure, the soft texture of the pet chew reinforced with the structure-providing component increases the amount of time that a pet will be chewing and the time the dental protection composition is in direct contact with the teeth.

The edible pet chews of the present invention can be formed using an injection molding process that provides significant control over the shape and texture of the pet chews. After the injection molding process, the pet chews are cured for an extensive amount of time, for example from several hours to five days (at room temperature), to aid in the evaporation of just the right amount of moisture such that the pet chew retains its malleability and does not become too hard. Typically, the curing process results in a moisture content of approximately 15 to 30%.

The pet chew can also include various flavoring ingredients such as beef liver powder, bacon bits, liver, fat, garlic, onion, anise, horsemeat, lamb, beef, cheese, fish, chicken, turkey and yeast to make the pet chew more acceptable to the animals. The pet chew can further include small amounts of humectant such as glycerin, sorbitol and polydextrose, and preservatives such as potassium sorbate to act as, for instance, a mold inhibitor. Other potential preservatives include sorbic acid and its salts, benzoic acid and its salts, calcium propionate, sodium nitrite, and disodium EDTA.

The edible pet chew has a moisture content of 15% to 30% (by weight) and comprises 15% to 35% by weight of gelatin, 10% to 30% by weight of flavoring ingredients, 2% to 10% by weight of structure-providing component, 1% to 5% by weight of humectant, 0.1% to 0.2% by weight of preservatives, and 10% to 25% by weight of a dental protection composition.

The dental protection composition of the edible pet chew can comprise 0.25 to 3% by weight of a transfer agent and 97 to 99.75% by weight of a barrier material. The transfer agent can be hexetidine, lecithin, cetyl amine, N-tallow-1,3-propanediamine, cetylpyridinium halide or combinations thereof. The barrier material can be a microcrystalline wax, a natural wax, a synthetic wax, a silicone-based polymer, a fluoropolymer or combinations thereof. The dental protection composition can also contain mineral oil.

A preferred embodiment of the edible pet chew is as follows. An edible pet chew having a moisture content of 18-20 wt % and comprising 15-35 wt % gelatin, 5-15 wt % beef liver, 5-15 wt % bacon bits, 1-5 wt % coconut fibers, 1-5 wt % powdered cellulose, 1-5 wt % glycerin, 0.1-0.2 wt % potassium sorbate, and 10-25 wt % of a dental protection composition comprising 0.25 to 3% by weight of a transfer agent, wherein the transfer agent comprises hexetidine and optionally further comprises one or more selected from lecithin, cetyl amine, N-tallow-1,3-propanediamine, and cetylpyridinium halide, and wherein the dental protection composition optionally further comprises a mineral oil. The dental protection composition preferably contains 2.5 wt % of hexetidine. The dental protection composition preferably contains 15-40 wt % of mineral oil; however, the dental protection composition could contain as low as 0 wt % of mineral oil if the remaining ingredients of the dental protection composition were such that the need for the properties associated with the mineral oil were satisfied by such remaining ingredients.

The inventors of the present invention also envision the possibility of the edible pet chew containing a core material which can be hard in nature or soft in nature. For example, the edible pet chew could contain rawhide as a core material that is encased in or coated with the above-noted formulations constituting the edible pet chew. Potential core materials that are hard in nature include rawhide and bully sticks or twists. Potential core materials that are soft in nature include nylon sticks and natural rubber.

### Example 1

An exemplary edible pet chew was produced according to the following compositional make-up:

| | |
|---|---|
| 35 wt % | gelatin |
| 15 wt % | beef liver powder |
| 5 wt % | coconut fibers |
| 0.1 wt % | potassium sorbate |
| 20 wt % | moisture |
| 20 wt % | a dental protection composition (OraVet ®) |

### II. Chewable Rope

The present invention also provides a chewable rope that provides a long lasting, inexpensive and effective means for assisting pets and their owners to maintain the pet's good oral health by allowing for a simple and practical method of applying/depositing a dental protection composition to the teeth of pets.

In a preferred embodiment, the chewable rope, which can be made from nylon, cotton or hemp for example, is impregnated with a dental protection composition in the amount of from 10% to approximately 25% by weight. A flavoring, which encourages chewing by an animal, can also be incorporated into the dental protection composition prior to rope impregnation. Exemplary flavoring can include catnip or cod liver oil for pets such as cats, or the flavoring can include a combination of cod liver oil, beef liver and beef broth for pets such as dogs. These flavorings can be incorporated separately into the rope, or the dental protection composition can be impregnated with one or more of the flavorings prior to the rope impregnation. Typical amounts of these flavorings in the dental protection composition can vary between 5% and 15% by weight.

The dental protection composition is the same as discussed above for the edible pet chew and comprises 0.25 to 3% by weight of a transfer agent and 10 to 25% by weight of a barrier material. The transfer agent can be hexetidine, lecithin, cetyl amine, N-tallow-1,3-propanediamine, cetylpyridinium halide or combinations thereof. The barrier material can be a microcrystalline wax, a natural wax, a synthetic wax, a silicone-based polymer, a fluoropolymer or combinations thereof. The dental protection composition can also contain mineral oil.

The dental protection composition, optionally containing one or more flavorings, can be applied to chewable rope by spraying in a spray chamber or by passing the chewable rope through a bath of the liquid form of the dental protection composition. The liquid form of the dental protection composition can be attained by heating said composition to a temperature within the range of 75 to 80° C. After impregnation of the chewable rope with the dental protection composition optionally containing one or more flavorings, the impregnated rope is then passed through a drying and cooling station.

The inventors of the present invention also envision the possibility of a chewable rope that comprises chewable rope as a core material and that also comprises any one of the above-described edible pet chew formulations as a coating surrounding the rope core.

1. An edible pet chew having a moisture content of 15% to 30% by weight and comprising 15% to 35% by weight of gelatin, 10% to 30% by weight of one or more flavoring ingredients, 2% to 10% by weight of one or more structure-providing components, 1% to 5% by weight of one or more humectants, 0.1% to 0.2% by weight of one or more preservatives, and 10% to 25% by weight of a dental protection composition.

2. The edible pet chew according to claim 1, wherein
the dental protection composition comprises 0.25% to 3% by weight of a transfer agent and 97% to 99.75% by weight of a barrier material,
the transfer agent comprises hexetidine and further comprises one or more selected from the groups consisting of lecithin, cetyl amine, N-tallow-1,3-propanediamine and cetylpyridinium halide,
the barrier material is one or more selected from the group consisting of a microcrystalline wax, a natural wax, a synthetic wax, a silicone-based polymer and a fluoropolymer, and
the dental protection composition optionally further comprises a mineral oil.

3. The edible pet chew according to claim 1, wherein the flavoring ingredients are one or more selected from the group consisting of beef liver powder, bacon bits, liver, fat, garlic, onion, anise, horsemeat, lamb, beef, cheese, fish, chicken, turkey and yeast.

4. The edible pet chew according to claim 1, wherein the structure-providing components are one or more selected from the group consisting of coconut fibers, powdered cellulose, hemp, cotton, coir, agave, silk, wool, alpaca and mohair.

5. The edible pet chew according to claim 1, wherein the humectants are one or more selected from the group consisting of glycerin, sorbitol and polydextrose.

6. The edible pet chew according to claim 1, wherein the preservatives are one or more selected from the group consisting of potassium sorbate, sorbic acid, a salt of sorbic acid, benzoic acid, a salt of benzoic acid, calcium propionate, sodium nitrite, and disodium EDTA.

7. A chewable rope comprising a rope impregnated with 10 to 25 wt % of a dental protection composition, wherein
the dental protection composition comprises 0.25% to 3% by weight of a transfer agent and 97% to 99.75% by weight of a barrier material,
the transfer agent comprises hexetidine and further comprises one or more selected from the groups consisting of lecithin, cetyl amine, N-tallow-1,3-propanediamine and cetylpyridinium halide,
the barrier material is one or more selected from the group consisting of a microcrystalline wax, a natural wax, a synthetic wax, a silicone-based polymer and a fluoropolymer, and
the dental protection composition optionally further comprises a mineral oil.

8. A chewable rope comprising a rope coated with the edible pet chew of claim 1.
